(19) United States
(12) Patent Application Publication
(10) Pub. No.: US 2022/0316950 A1
(43) Pub. Date: Oct. 6, 2022

(54) FIRE PRE-DETECTION DEVICE

(71) Applicant: INTECH CO., LTD., Ulsan (KR)

(72) Inventors: Young Soo Kim, Gyeongsangnam-do (KR); Sang Yong Song, Ulsan (KR); Yun Sung Lee, Ulsan (KR)

(21) Appl. No.: 17/596,019

(22) PCT Filed: Nov. 14, 2019
(86) PCT No.: PCT/KR2019/015551

§ 371 Date: Dec. 1, 2021

(30) Foreign Application Priority Data
Aug. 20, 2019 (KR) 10-2019-0101503

(51) Int. Cl. G01J 5/00; G06V 10/25; G06V 10/50; G06V 20/52; G08B 17/12

(52) U.S. Cl. CPC G01J 5/0018; G06V 10/25; G06V 10/50; G06V 20/52; G08B 17/125; G01J 2005/0077

(57) ABSTRACT

The present invention relates to a fire pre-detection device and, particularly, to a fire pre-detection device for pre-detecting a fire on the basis of the difference between a temperature of a thermal image acquired by a thermal imaging camera and a temperature of a differential thermal image, and finally detecting the fire by using a flame detector. The fire pre-detection device according to the present invention can pre-detect a fire sign or a fire through a thermal image and finally detect the fire through the flame detector, so as to pre-detect a fire and more clearly detect the occurrence of a fire.

### CROSS-REFERENCE TO RELATED APPLICATION(S)

This application is the national phase of PCT Application No. PCT/KR2019/015551 filed on Nov. 14, 2019, which claims priority to Korean Patent Application No. 10-2019-0101503 filed on Aug. 20, 2019, both of which are incorporated herein by reference in their entireties.

### BACKGROUND

### Field

The present disclosure relates to a fire pre-detection device, and, more specifically, to a fire pre-detection device which pre-detects fire based on a temperature of a thermal image acquired with a thermal imaging camera and a temperature difference in a thermal image difference and finally detects the fire with a flame detector.

### Description of Related Art

Fire is caused unintentionally or intentionally by humans. The fire may include building fires that occur in buildings, forest fires that occur in mountains or fields, and vehicle fires that occur in vehicles, depending on a place where they occur. In occurrence of the fire, damage to property or human life is high. Thus, it is important to pre-detect the fire or to detect the fire quickly and cope with the fire. Therefore, a fire detection device that detects the fire rather than a person is installed in a place where fire may occur.

However, a conventional fire detection device performs high temperature detection or flame detection and detects a sign that appears after the fire. Therefore, there is a demand for a fire pre-detection device that may detect the fire before the fire occurs as quickly as possible.

### SUMMARY

A purpose of the present disclosure is to provide a fire pre-detection device capable of pre-detection of fire.

The purpose of the present disclosure is not limited to the above-mentioned purpose, and other purposes and advantages of the present disclosure that are not mentioned may be understood based on following descriptions, and may be more clearly understood based on embodiments of the present disclosure. Further, it will be readily apparent that the purposes and advantages of the present disclosure may be realized by means and combinations thereof indicated in the claims.

A fire detection device according to the present disclosure includes a thermal imaging camera for acquiring a thermal image of a fire detection region; a flame detector for detecting a flame of the fire detection region; and a controller configured to: determine whether fire is pre-detected based on a temperature-difference in a thermal image difference between thermal images acquired at different timings using the thermal imaging camera or based on a limit temperature; and upon determination that the fire is pre-detected, activate the flame detector to finally detect the fire.

The controller includes: a block defining module configured to group a plurality of pixels in the thermal image into a plurality of blocks; a ROI defining module configured to group adjacent blocks among the plurality of blocks into a ROI (region of interest) having higher fire detection sensitivity than fire detection sensitivity of each of neighboring blocks thereto; a fire candidate block detection module configured to determine, as a fire candidate block, a ROI or a surrounding block adjacent thereto when the temperature-difference in the thermal image difference in the ROI or the surrounding block is greater than or equal to a reference value or the highest temperature in the ROI or the surrounding block is greater than or equal to the limit temperature; a fire detection sensitivity control module configured to increase a fire detection sensitivity of the fire candidate block; and a fire pre-detection module configured to determines that fire has occurred when the temperature-difference in the fire candidate block has been greater than or equal to the reference value for a predetermined time duration or greater, or the highest temperature in the fire candidate block is greater than or equal to the limit temperature for a predetermined time duration or greater.

The controller further includes a flame detection module configured to detect the flame based on a signal obtained using the flame detector, wherein the flame detection module includes: a flame detection sensitivity control module configured to increases a sensitivity of the flame detector when the fire pre-detection module determines that the fire has occurred; and a fire detection module configured to detect the fire based on the signal from the flame detector.

The controller further includes a gas leak detection module configured to determine that gas leak has occurred when the temperature-difference in the fire candidate block has been lower than the reference value for a predetermined time duration or greater, or the highest temperature in the fire candidate block is lower than the limit temperature for a predetermined time duration or greater.

The fire pre-detection device according to the present disclosure may pre-detect fire signs or fire based on the thermal image and may perform final detection of the fire using the flame detector, and thus may detect the fire occurrence more clearly.

In addition to the above-described effects, the specific effects of the present disclosure will be described together while describing specific details for carrying out the disclosure below.

### BRIEF DESCRIPTION OF THE DRAWINGS

FIG. 1 is a schematic perspective view of a fire pre-detection device according to the present disclosure.

FIG. 2 is a block diagram of a fire pre-detection device according to the present disclosure.

FIG. 3 is a conceptual diagram for illustrating a thermal image detection module of a fire pre-detection device according to the present disclosure.

FIG. 4 is a flowchart of a fire pre-detection method according to the present disclosure.

### DETAILED DESCRIPTION

The above-described purposes, features and advantages will be described later in detail with reference to the accompanying drawings, and accordingly, a person of ordinary skill in the art to which the present disclosure belongs will be able to easily implement the technical idea of the present disclosure. In describing the present disclosure, when it is determined that detailed description of a known component related to the present disclosure may unnecessarily obscure the gist of the present disclosure, the detailed description will be omitted. Hereinafter, a preferred embodiment according to the present disclosure will be described in detail with reference to the accompanying drawings. In the drawings, the same reference numerals are used to indicate the same or similar components.

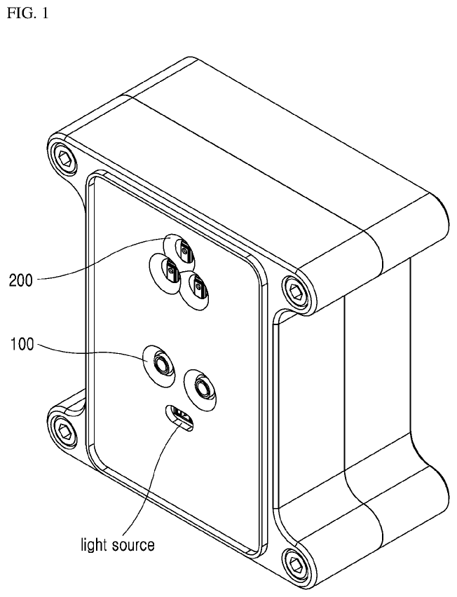

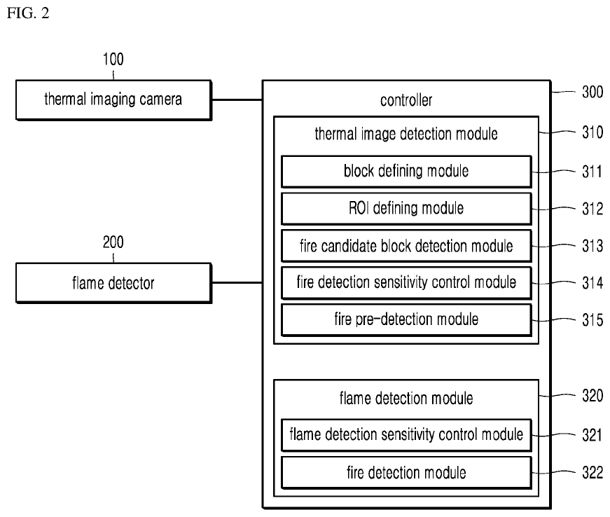

FIG. 1 is a schematic perspective view of a fire pre-detection device according to the present disclosure, and FIG. 2 is a block diagram of a fire pre-detection device according to the present disclosure.

A fire pre-detection device according to the present disclosure as shown in FIGS. 1 and 2 includes a thermal imaging camera 100 for acquiring a thermal image of a fire detection region, a flame detector 200 for detecting flame in the fire detection region, and a controller 300 that finally detects fire by operating a flame detector when fire is pre-detected based on a temperature-difference in a thermal image difference between thermal images acquired at different times, or based on a limit temperature.

The thermal imaging camera 100 acquires a thermal image in the fire detection region, and the flame detector 200 detects a flame in the fire detection region. As shown in FIG. 1, the flame detector 200 and the thermal imaging camera 100 are spaced apart from each other and provided with different transparent covers.

The controller 300 pre-detects whether fire occurs in the fire detection region based on the thermal image obtained from the thermal imaging camera 100, and finally detects the fire with the flame detector. To this end, the controller 300 includes a thermal image detection module 310 that pre-detects whether fire has occurred in the fire detection region based on the thermal image obtained from the thermal imaging camera 100, and a flame detection module 320 that finally detects whether fire has occurred in the fire detection region.

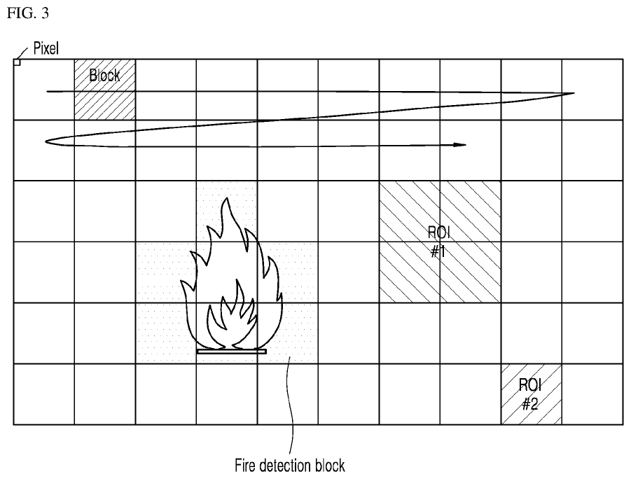

FIG. 3 is a conceptual diagram for illustrating a thermal image detection module of a fire pre-detection device according to the present disclosure.

The thermal image detection module 310 detects presence or absence of fire in the fire detection region based on the thermal image of the fire detection region obtained from the thermal imaging camera 100. To this end, the thermal image detection module 310 includes a block defining module 311 that groups a plurality of pixels in the thermal images into blocks, a ROI defining module 312 which groups adjacent blocks among the multiple blocks to define a ROI (region of interest) having higher fire detection sensitivity than those of neighboring blocks, a fire candidate block detection module 313 which determines, as a fire candidate block, a ROI or a surrounding block adjacent thereto when a temperature-difference in a thermal image difference between thermal images acquired at different timings in the ROI or the surrounding block is greater than or equal to a reference value or the highest temperature in the ROI or the surrounding block is greater than or equal to a limit temperature, a fire detection sensitivity control module 314 to increase a fire detection sensitivity of the fire candidate block, and a fire pre-detection module 315 that determines that fire has occurred when the temperature-difference in the fire candidate block has been greater than or equal to the reference value for a predetermined time duration or greater, or the highest temperature in the fire candidate block is greater than or equal to the limit temperature for a predetermined time duration or greater.

The block defining module 311 defines a block in one region of the thermal image of the fire detection region acquired by the thermal imaging camera 100. In this connection, the block refers to a group of at least one or more pixels. In this embodiment, a plurality of pixels adjacent to each other are grouped to define one block, and a thermal image is defined to have a plurality of blocks. Further, this embodiment exemplifies grouping a plurality of pixels so that the block has a rectangular shape or a square shape. In this embodiment, the thermal image is divided into a plurality of blocks having the same shape and size. In this connection, when the block defining module 311 defines the block, block information may be created. The block information includes grouped pixel location information in the block and block location information. In one example, the block defining module 311 may change the shape and size of the block according to the computing power of the fire pre-detection device. That is, the block defining module 311 may automatically determine the computing capability of the fire pre-detection device and may change the shape and size of the defined block based on the computing power. When the size of the block is reduced while the shape of the block is fixed, the number of blocks in the thermal image increases. Accordingly, the computational power required to compute one thermal image also increases. Therefore, the block defining module 311 may fix the shape of the block into a square shape, for example, and then may reduce the size of the block, and then may determine whether the computing of the blocks in the thermal image, that is, fire detection may be completed within a predetermined time duration, and may define the smallest size block in which the fire detection of the thermal image (thermal image difference) may be completed within the predetermined time duration.

Further, although the above-described embodiment exemplifies that a plurality of blocks have the same shape and size, the present disclosure is not limited thereto. That is, according to the present disclosure, a plurality of blocks may have different shapes and sizes. In this case, the device may increase the resolution of the ROI by making the block size of the ROI smaller than the size of the block other than the ROI although the blocks have the same shape.

The ROI defining module 312 defines the ROI (Region-Of-Interest) by grouping at least one block defined by the block defining module 311. In this connection, the ROI may be defined as a region where fire is likely to occur in the fire detection region, for example, an region where fire may occur due to heat, such as an region where manufacturing equipment is located in a factory. Further, the ROI defining module 312 generates ROI information including information on blocks defined as the ROI, that is, block information about the blocks defined as the ROI. Further, the generated ROI information may be used to specify the block defined as the ROI.

The fire candidate block detection module 313 detects the fire candidate block from the thermal image difference between the thermal images which are acquired from the thermal imaging camera 100 and in which the ROI is defined. To this end, the fire candidate block detection module 313 generates the thermal image difference as a difference between the thermal images in which the ROI is defined by the ROI defining module 312, that is, the thermal images of frames temporally adjacent to each other. In this connection, the thermal image difference refers to a difference between the plurality of thermal images as acquired by the thermal imaging camera 100. For example, the fire candidate block detection module 313 may detect the fire candidate block from a first thermal image difference between a first thermal image and a second thermal image as a frame obtained after acquiring the first thermal image, and may detect the fire candidate block from a second thermal image difference between the second thermal image and a third thermal image as a frame obtained after acquiring the second thermal image. Further, the fire candidate block detection module 313 determines a specific block as the fire candidate block when the temperature-difference in the thermal image difference in the specific block is greater than or equal to the reference value or the highest temperature of the specific block in the thermal image is greater than the limit temperature.

The fire detection sensitivity control module 314 increases the fire detection sensitivity of the block detected as the fire candidate block by the fire candidate block detection module 313. For example, before controlling the fire detection sensitivity, the thermal image difference in the ROI may be created every 10 frames and the temperature-difference therein may be determined. The highest temperature in the ROI may be determined from the thermal image every 10 frames. However, when the fire detection sensitivity is increased, the thermal image difference in the ROI may be created every less than 10 frames, for example, every 5 frames, and the temperature-difference therein may be determined. The highest temperature in the ROI may be determined from the thermal image every less than 10 frames, for example, every 5 frames. That is, the fire detection sensitivity control module 314 may control the fire detection sensitivity by adjusting a reference thermal image frame and a reference thermal image difference frame for detecting the fire.

The fire pre-detection module 315 determines that it is a fire pre-sign when the temperature difference related to the block detected as the fire candidate block in the fire candidate block detection module 313 has exceeded a temperature-difference reference value for more than a predetermined time duration or the highest temperature in the block has exceeded the limit temperature for more than a predetermined time duration. Further, when the fire candidate block is detected, the fire pre-detection module 315 notifies this block to a manager of the device so that the fire may be prevented in advance. In this connection, the notification may include presenting an alarm on a registered manager terminal, or may presenting the notification using a light source or a speaker possessed by the fire pre-detection device itself, or a light source or a speaker or a display provided at a location desired by the manager.

The flame detection module 320 detects a flame in the fire detection region determined to have a fire pre-sign or fire event by the fire pre-detection module 315. For this purpose, the flame detection module 320 includes a flame detection sensitivity control module 321 and a fire detection module 322.

The flame detection sensitivity control module 321 increases the sensitivity of the flame detector 200 for detecting the flame in the fire detection region determined to have a fire pre-sign or fire event by the fire pre-detection module 315. This may be done by the flame detection sensitivity control module 321 increasing a flame detection distance by which the flame is detected and increasing a flame detection speed at which the corresponding flame detector 200 detect the flame. In one example, this embodiment illustrates that the flame detection sensitivity control module 321 increases the sensitivity at which the flame in the fire detection region as determined to have a fire pre-sign or fire event by the fire pre-detection module 315 is detected. However, the present disclosure is not limited thereto. For example, when the fire detection module 322 to be described later fails to detect the flame in the fire detection region determined to have a fire pre-sign or fire event by the fire pre-detection module 315, the flame detection sensitivity control module 321 may increase the sensitivity such that the fire detection module 322 may re-detect the flame at the increased sensitivity.

The fire detection module 322 may detect the flame in the fire detection region determined to have the fire pre-sign or fire event by the fire pre-detection module 315 and finally determines whether or not the fire occurs, based on the detecting result.

As described above, in accordance with the present disclosure, the fire sign may be pre-detected based on the thermal image and then final detection of the fire may be made using the flame detector, such that the fire occurrence may be more clearly detected.

The controller may further include a gas leak detection module configured to determine that gas leak has occurred when the temperature-difference in the fire candidate block has been lower than the reference value for a predetermined time duration or greater, or the highest temperature in the fire candidate block is lower than the limit temperature for a predetermined time duration or greater.

Next, a fire pre-detection method according to the present disclosure will be described with reference to the drawings. Descriptions reduplicate with the above descriptions of the fire pre-detection device according to the present disclosure as described above will be omitted or briefly described.

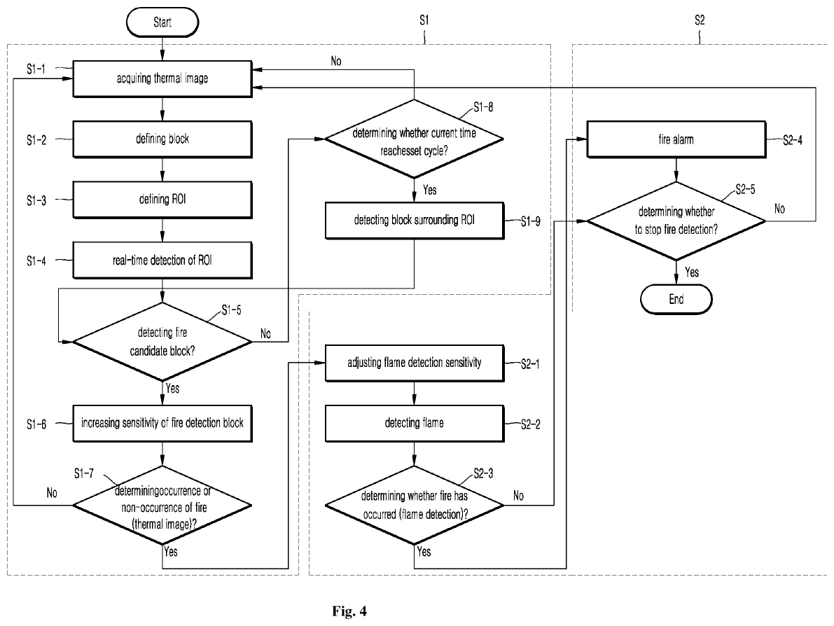

FIG. 4 is a flowchart of a fire pre-detection method according to the present disclosure.

The fire pre-detection method according to the present disclosure includes a step S1 of pre-detection of fire based on a thermal image and a step S2 of final detection of fire based on a flame, as shown in FIG. 4.

The step S1 of pre-detecting fire based on the thermal image is to pre-detect the occurrence of fire in the fire detection region based on the thermal image of the fire detection region obtained from the thermal imaging camera. To this end, the step S1 of pre-detecting fire based on the thermal image may include a step S1-1 of acquiring a thermal image, a step S1-2 of defining the block, a step S1-3 of defining the ROI, a step S1-4 of real-time detection of the ROI, a step S1-5 of detecting a fire candidate block, a step S1-6 of increasing the sensitivity of the fire detection block, a step S1-7 of determining the occurrence or non-occurrence of the fire, a step S1-8 of determining whether a current time reaches a set cycle, and a step S1-9 of detecting a block surrounding the ROI.

In the step S1-1 of acquiring the thermal image, a thermal image of the fire detection region is acquired with a thermal imaging camera.

In the step S1-2 of defining the block, a block defining module defines a block in the thermal image obtained in the step S1-1 of acquiring the thermal image. In this connection, one block refers to a group of a plurality of pixels adjacent to each other as described above, and a thermal image is defined to have a plurality of blocks.

The step S1-3 defining the ROI defines the ROI in the thermal image where the block is defined in the step S1-2 of defining the block. In this connection, the ROI may be defined as the area where fire is likely to occur in the fire detection region, for example, an area where fire may occur due to heat, such as an area where manufacturing equipment is located in a factory.

In the step S1-4 of the real-time detection of the ROI, the fire is detected while allocating a first priority to the ROI defined in the step S1-3 defining the ROI and allocating a second priority to the blocks other than the ROI. For example, when the fire detection operation in the ROI in the thermal image obtained from the thermal imaging camera is performed once every 5 seconds, the fire detection operation in the blocks other than the ROI may be performed once every 10 seconds. Further, in the step S1-4 of the real-time detection of the ROI, it is detected whether the highest temperature in the ROI of the thermal image exceeds the limit temperature or the temperature-difference value in the thermal image difference in the ROI exceeds the temperature-difference reference value.

In the step S1-5 of detecting the fire candidate block, the fire candidate block detection module configured to determine, as a fire candidate block, a ROI or a surrounding block adjacent thereto when the temperature-difference in the thermal image difference in the ROI or the surrounding block is greater than or equal to a reference value or the highest temperature in the ROI or the surrounding block is greater than or equal to the limit temperature.

The step S1-6 of increasing the sensitivity of the fire detection block may increase the fire detection sensitivity of the block determined as the fire candidate block in the step S1-5 of detecting the fire candidate block. In this connection, the increase in the fire detection sensitivity may be performed by reducing a fire detection cycle.

In the step S1-7 for determining the occurrence or non-occurrence of fire, the fire pre-detection module determines that fire has occurred when the temperature-difference in the fire candidate block has been greater than or equal to the reference value for a predetermined time duration or greater, or the highest temperature in the fire candidate block is greater than or equal to the limit temperature for a predetermined time duration or greater.

In the step S1-8 of determining whether a current timing reached the set cycle, when it is not determined as the fire event in step S1-7 of determining the occurrence or non-occurrence of fire, the fire pre-detection module determines whether the current timing reaches the set ROI detection cycle. For example, the set ROI detection cycle may be 10 frames or 5 seconds. Thus, when the current timing has reached the set ROI detection cycle, the block around the ROI is detected.

When the current timing has reached the set ROI detection cycle in the step S1-8 of determining whether a current timing reached the set cycle, the fire pre-detection module detects fire in the block around the ROI in the step S1-9 of detecting the block around the ROI.

In the step S2 of the final detection of the fire based on the flame, when it is determined that the fire has occurred in a specific block in the step S1-7 of determining the occurrence or non-occurrence of the fire, the flame detection module detects the flame of the fire detection region corresponding to the specific block using the flame detector, and thus finally detects the fire based on the flame. To this end, the step S2 of final detection of the fire based on the flame may include a step S2-1 of adjusting the flame detection sensitivity, a step S2-2 of detecting a flame, a step S2-3 of determining whether the fire has occurred, a fire alarm step S2-4, and a step S2-5 of determining whether to stop the fire detection.

The step S2-1 of adjusting the flame detection sensitivity increases the flame detector sensitivity of the fire detection region in which the fire event is determined to occur in the step S1-7 for determining the occurrence or non-occurrence of the fire. This may be done by increasing the flame detection distance of the corresponding flame detector or decreasing the flame detection time duration thereof.

In the step S2-2 of detecting a flame, a flame is detected in the fire detection region in which the fire event is determined to occur in the step S1-7 for determining the occurrence or non-occurrence of the fire.

In the step S2-3 of determining whether or not the fire occurs, when the flame is detected through the flame detector in the step S2-2 of detecting the flame, it is finally determined that the fire has occurred.

In the fire alarm step S2-4, when it is determined that the fire has occurred in the step S2-3 of determining whether the fire has occurred, the fire pre-detection module notifies the block in which the fire has occurred to a manager of the device so that the fire may be prevented in advance. In this connection, the notification may include presenting an alarm on a registered manager terminal, or may presenting the notification using a light source or a speaker possessed by the fire pre-detection device itself, or a light source or a speaker or a display provided at a location desired by the manager.

In the step S2-5 of determining whether to stop fire detection, it is determined whether to stop the fire detection based on a user input to stop fire detection or the like. In this connection, when the fire detection is not stopped, the process from the step S1-1 to acquire the thermal image to the step S2-4 may be repeated.

As described above, the present disclosure has been described with reference to the illustrated drawings. However, the present disclosure is not limited to the embodiments and drawings disclosed in the present specification. It is obvious that those of ordinary skill in the art may have various modifications within the scope of the technical idea of the present disclosure. In addition, although the effect of the configuration of the present disclosure is not explicitly described above while describing the embodiments of the present disclosure, it is natural that the predictable effect from the configuration should also be appreciated.

1. A fire detection device comprising:
a thermal imaging camera for acquiring a thermal image of a fire detection region;
a flame detector for detecting a flame of the fire detection region; and
a controller configured to:
determine whether fire is pre-detected based on a temperature-difference in a thermal image difference between thermal images acquired at different timings using the thermal imaging camera or based on a limit temperature; and
upon determination that the fire is pre-detected, activate the flame detector to finally detect the fire.

2. The device of claim 1, wherein the controller includes:
a block defining module configured to group a plurality of pixels in the thermal image into a plurality of blocks;
a region-of-interest (ROI) defining module configured to group adjacent blocks among the plurality of blocks into a ROI having higher fire detection sensitivity than fire detection sensitivity of each of neighboring blocks thereto;
a fire candidate block detection module configured to determine, as a fire candidate block, a ROI or a surrounding block adjacent thereto when the temperature-difference in the thermal image difference in the ROI or the surrounding block is greater than or equal to a reference value or a highest temperature in the ROI or the surrounding block is greater than or equal to the limit temperature;
a fire detection sensitivity control module configured to increase a fire detection sensitivity of the fire candidate block; and
a fire pre-detection module configured to determines that fire has occurred when the temperature-difference in the fire candidate block has been greater than or equal to the reference value for a predetermined time duration or greater, or the highest temperature in the fire candidate block is greater than or equal to the limit temperature for a predetermined time duration or greater.

3. The device of claim 2, wherein the controller further includes a flame detection module configured to detect the flame based on a signal obtained using the flame detector, wherein the flame detection module includes:
a flame detection sensitivity control module configured to increase a sensitivity of the flame detector when the fire pre-detection module determines that the fire has occurred; and
a fire detection module configured to detect the fire based on the signal from the flame detector.

4. The device of claim 3, wherein the controller further includes a gas leak detection module configured to determine that a gas leak has occurred when the temperature-difference in the fire candidate block has been lower than the reference value for a predetermined time duration or greater, or the highest temperature in the fire candidate block is lower than the limit temperature for a predetermined time duration or greater.
